(19) United States
(12) Patent Application Publication
(10) Pub. No.: US 2005/0045427 A1
(43) Pub. Date: Mar. 3, 2005

(54) Method for making and installing an elevator with a scissor lift mechanism

(76) Inventors: Jean-Marie Rennetaud, Fox River Valley Gardens, IL (US); Tian Zhou, Reussbuhl (CH)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/914,419

(22) Filed: Aug. 9, 2004

(30) Foreign Application Priority Data
Sep. 2, 2003 (EP) 03405633.3

(51) Int. Cl. B66B 9/02

(52) U.S. Cl. 187/269; 187/211; 254/122

(57) ABSTRACT

A method for making a scissor elevator assembly includes the steps of providing a mounting platform for being arranged on a support surface, providing a scissor assembly with at least two scissor columns for carrying an elevator car and being arranged underneath the elevator car, each scissor column having at least one pair of arms, and providing a drive mechanism that is capable of applying a force for unfolding the scissor assembly. A module is pre-assembled by securing the scissor columns to the mounting platform for installment on-site and the function of the scissor columns is examined.

### BACKGROUND OF THE INVENTION

The present invention generally relates to elevators and, more particularly, is concerned with an elevator with a scissor lift mechanism.

In various work platform lift machines, such as scissors lifts, elevated platforms, cranes, etc., hydraulic cylinders are used to provide the necessary lifting forces. One of most popular machines of this type is called an electric slab scissor lift machine. Electric slab scissor lift machines comprise a scissor lift mechanism mounted at a lower end on a chassis, a work platform mounted on an upper end of the lift mechanism for carrying persons, and a hydraulic actuation system for operating the lift mechanism to raise and lower the work platform. The scissor lift mechanism includes a plurality of pairs of arms pivotally interconnected in a scissor-like fashion so as to raise and lower as the arms pivot between generally vertical unstacked and horizontal stacked orientations relative to one another. The hydraulic actuation system generally employs two or more hydraulic cylinders for causing pivoting of the pairs of arms to expand the lift mechanism. Typically, the hydraulic cylinders are interconnected between an adjacent pair of the arms.

An example of a lift machine with two symmetrically arranged hydraulic actuation systems is described in the U.S. Pat. No. 5,375,681, which belongs to the same family as the German patent application DE 42 25 871-A1. Each of the two hydraulic actuation systems provides for the up and down movement of one of two scissor columns which together carry an elevator car. Two vertical guiding means are provided which are symmetrically arranged with respect to the scissor columns of the lift machine. The guiding means are rather complicated and the actuation of the two hydraulic actuation systems has to be synchronized.

Other examples a lift machines with two symmetrically arranged hydraulic actuation systems are described in the German patent applications DE 42 34 490-A1 and DE 195 18 715-A1.

The assembly and installation is addressed only in very few words in the prior art documents. In the German patent application DE 42 34 490-A1, it is only mentioned that the scissor columns are being fixed on the ground or on a base plate by means of screws and that the pump of the hydraulic mechanism is put next to the base plate. These elements are all installed individually on-site. In the German patent application DE 195 18 715-A1, it is described that the lift is installed by putting a base plate on the floor. Then, the first scissor column and the second scissor column are attached to the base plate. In a next step, the elevator cabin is attached to the two columns and the hoses or pipes are attached to the hydraulic actuation systems.

The use of hydraulic actuation systems and positioning of the hydraulic cylinders in lift machines have several disadvantages, but there are other scissor mechanisms that use electro-mechanical drives for actuation.

Scissor based lifting mechanisms are well suited for elevators, in particular elevators that are designed to be employed in buildings with less than four floors. The hoistway, if needed at all, does not need to be much larger than the cross-section of the elevator platform, since all the mechanical elements as well as the actuation mechanism sits underneath the elevator platform.

It is a disadvantage of the scissor based elevators known so far, that they are mechanically complex. The making and in particular the on-site installation of such elevators is time consuming and difficult. The fact that the scissor based elevators, as described in the prior art documents, are installed piece-by-piece on-site, adds substantially to the overall costs. It is another disadvantage of the known approaches, that they require skilled workmen to install the elevator on-site to ensure that the elevator is stable and well balanced.

Consequently, a need exists for a different approach to making and installing the scissors based elevators to overcome the above-mentioned disadvantages without introducing other disadvantages in their place.

### SUMMARY OF THE INVENTION

The present invention concerns a method for making a scissor elevator assembly and a method for installing such a scissor elevator assembly. Various embodiments are discussed herein.

The elevator, according to the present invention, has the following advantages:
Stability is a crucial issue in particular when using a scissor elevator. It is an advantage of the assembling and testing can be done in a factory or testing site, respectively.
Quality and safety tests can be carried out more easily before shipment of the assembly.
The pre-fabricated elevator can be installed more easily on site. This helps to drastically reduce the overall costs of the elevator, since the installation costs of conventional elevators are about 30-60% of the overall costs.
The on-site installment is less complicated and less time consuming. No mechanical experts are needed for the installation.
The on-site installation is faster and the whole building can be finished more quickly.
No special tools are needed for on-site installation; that is regular workmen can take care of the installation.
In one particular embodiment, the side walls of the hoistway can be attached to the mounting platform. This allows for a precise definition of the size and shape of the hoistway and helps to avoid that the elevator car or cabin contacts the walls as it moves up or down.

The above advantages do not necessarily apply to all the different embodiments, since the embodiments are implementations of the invention with a focus on optimizing particular aspects. At the same time, however, other aspects might be less perfect.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1A is a schematic perspective representation of a first embodiment of an elevator according to the present invention;

FIG. 1B is an enlarged view of the first elevator shown in FIG. 1A;

FIG. 2 is a schematic perspective representation of the lower part of a second embodiment of an elevator according to the present invention; and

FIG. 3 is a view of a pre-assembled module of the elevator shown in FIG. 1A being arranged on a transport platform, ready for transport.

### DESCRIPTION OF THE PREFERRED EMBODIMENT

In the following description, like reference characters designate like or corresponding parts throughout the several views of the drawings. Also in the following description, it is to be understood that such terms as “horizontal”, “vertical”, “left”, “right”, “upwards”, “downwards”, and the like are words of convenience and are not to be construed as limiting terms.

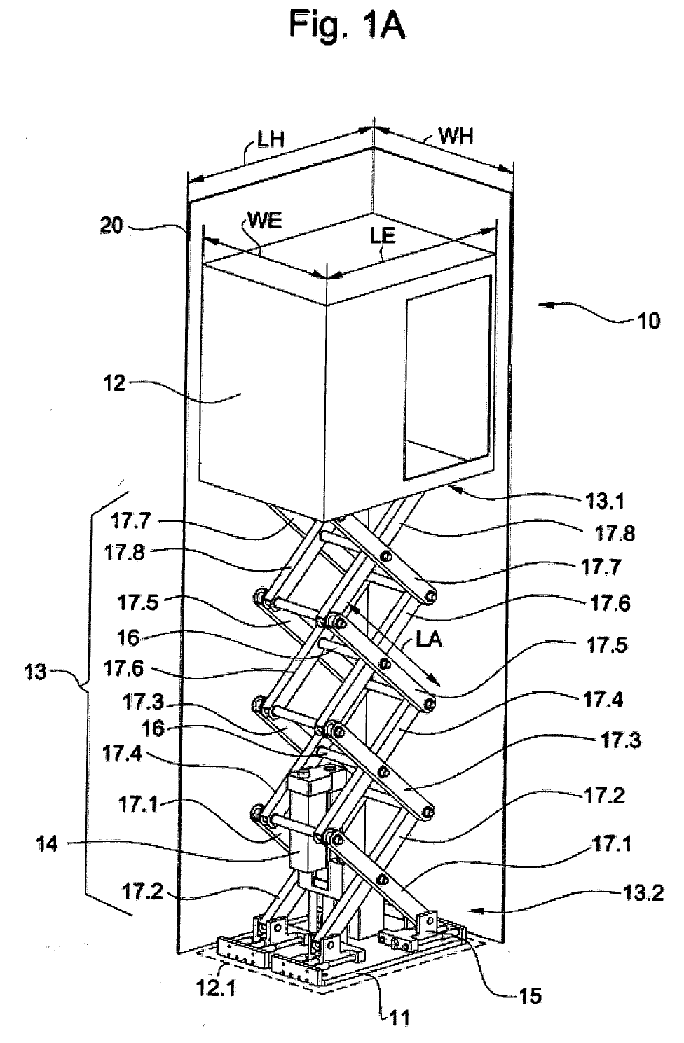

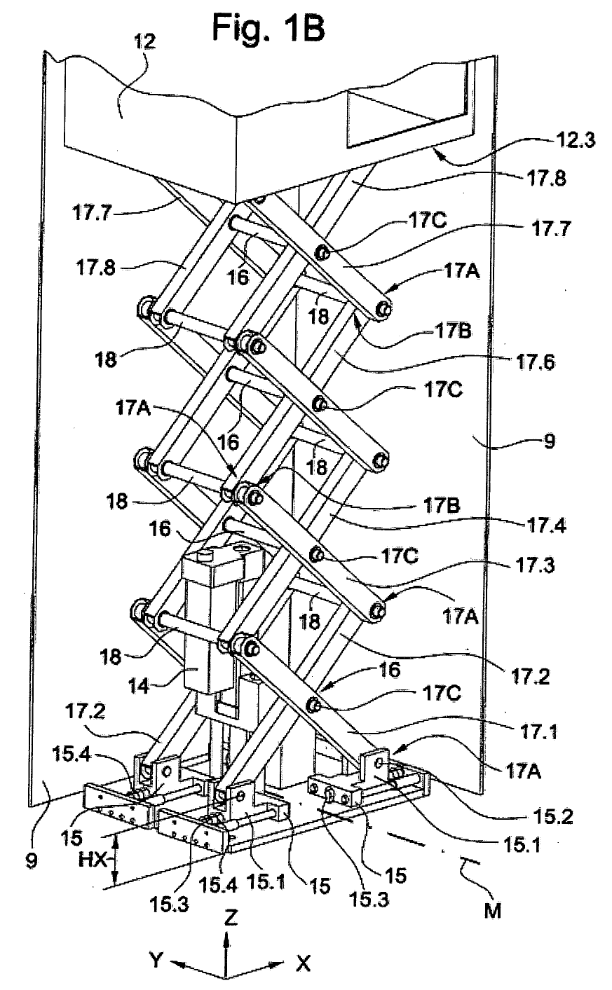

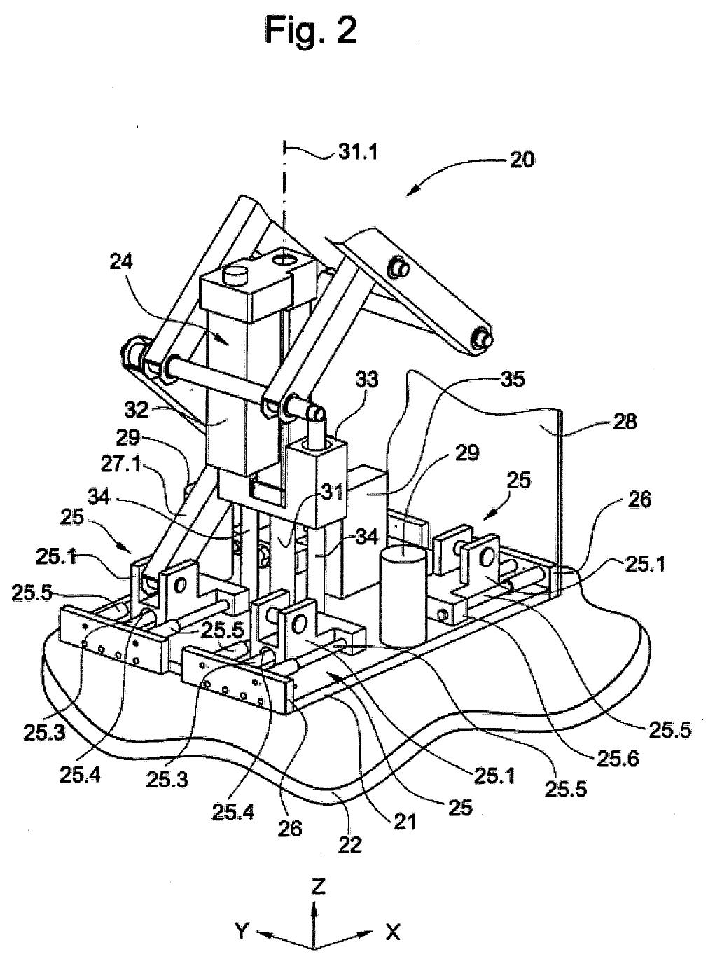

Referring to the drawings and particularly to FIGS. 1A, 1B, and 2, there are illustrated various scissors-type elevators of the present invention.

In FIGS. 1A and 1B, a first embodiment of an elevator 10 is shown. The elevator 10 basically comprises a mounting platform 11, an elevator car 12, a scissor assembly 13, and an electro-mechanical drive 14. The elevator car 12 is disposed above the mounting platform 11. The scissor assembly 13 extends vertically between the mounting platform 11 and the elevator car 12 and has four upper ends 13.1 (not visible in the drawings) pivotally mounting the elevator car 12 and four lower ends 13.2 horizontally mounted and guided by guiding means 15 on the mounting platform 11. The scissor assembly 13 comprises two scissor columns which preferably are substantially identical to ensure symmetry of the overall system. The two scissor columns are situated parallel to each other on either side of the elevator car 12 and are connected by at least one horizontal cross element 16. A rod or tube may serve as the cross element 16, for example. Each scissor arrangement comprises a plurality of portions in the form of pairs of arms 17.1 and 17.2, 17.3 and 17.4, 17.5 and 17.6, and 17.7 and 17.8 being pivotally interconnected in a scissors-like fashion and movable relative to one another between expanded and retracted conditions so as to move the elevator car 12 between raised and lowered positions relative to the mounting platform 11.

Each pair of arms of the scissor assembly 13 comprises two longitudinal arms. The lower most pair of arms comprises the two arms 17.1, 17.2, for example. The arms 17.x, where “x” represents an integer, may have a solid or hollow tubular construction and they may have a substantially rectangular, circular, triangular or oval cross-section. Although the arms 17.x may have any other suitable configuration. A length LA of each arm 17.x is smaller than a respective length LE (side-to-side) of the elevator car 12 if the scissor assembly 13 is to stay within a projection 12.1 of the elevator car 12. In this case, a length LH (side-to-side) and a width WH (front-to-rear) of an optional hoistway 20 is only slightly larger than the length LE and a width WE (front-to-rear) of the elevator car 12. It is, however, also possible to employ the arms 17.x having the length LA that is greater than the length LE of the elevator car 12.

Each arm, e.g. the arm 17.3, has a pair of opposite ends 17A, 17B, as illustrated in FIG. 1B, and is disposed in substantially parallel relation to the other respective arm 17.4 of the pair. The scissor assembly 13 also includes a plurality of intersection points 17C and the cross elements 16 horizontally extending between and pivotally connected respectively with corresponding ones of the arms 17.x at the intersection points 17C. The arm 17.3 is at its respective end 17B pivotally connected to the end 17A of the next arm 17.6, and so forth. Furthermore, there are optional cross elements 18 horizontally extending and pivotally connected respectively between corresponding ones of the arms 17.x of the two parallel scissor columns. The cross elements 18 may be connected to the arms 17.x at or close to the respective ends 17A, 17B.

The elevator car 12 is of any suitable type such as the one shown in FIG. 1A and FIG. 1B. An underside 12.3 of the elevator car 12 is mounted to the uppermost pairs of arms 17.7, 17.8 in a fashion that may be substantially similar to the mounting of the lowermost pairs of arms 17.1, 17.2 to the guiding means 15. The mounting is done in a way that the respective uppermost pairs of arms 17.7, 17.8 and lowermost pairs of arms 17.1, 17.2 can move in a horizontal direction “X” relative to the elevator car 12 and the mounting platform 11 so as to allow for the expansion and retraction of the scissor assembly 13.

The guiding means 15 on the mounting platform 11 ensure that the four lower ends of the two lowermost pairs of arms are kept at a certain height HX above ground. In the present embodiment, the height HX is fixed. It is, however, possible to define a range Hmin to Hmax in which the lower ends of the arms are allowed to move.

In FIG. 1B, details of the guiding means 15 are shown. Each of the lower ends of the four arms 17.1, 17.2 is mounted and guided in the respective guiding means 15. The lower end 17A of the arm 17.1, for example, is pivotally connected to a horizontal slide 15.1. The arm 17.1 may be connected to the horizontal slide 15.1 by means of a pin 15.2, axle or screw, for example. Each of the guiding means 15, according to the present embodiment, comprises a central non-threaded shaft 15.3 which is arranged parallel to the ground or parallel to the mounting platform 11 and parallel to the “X” axis. The horizontal slide 15.1 comprises a through hole and the shaft 15.3 extends through this hole. In the present embodiment, there are four guiding means 15 situated on the mounting platform 11. The horizontal slides 15.1 can move parallel to the “X” axis along the shafts 15.3. According to the present invention, the guiding means 15 comprise at least one spring element 15.4 (e.g. a compression spring) acting on the lower ends of the arms to provide an upwards oriented counterforce. According to the present embodiment, the spring element is arranged co-axially with the central shaft 15.3. A spring may be wound around the shaft, or a spring may be integrated into the shaft 15.3.

For improved symmetry, there may be one spring element on the left hand side of the central shaft 15.3 and one spring element on the right hand side thereof, as described in connection with the embodiment illustrated in FIG. 2.

The spring elements are arranged so that they interact with the sliding element 15.1 to bias it towards an unfolded position of the elevator. Preferably, the spring element is guided by a horizontal shaft (e.g. the central shaft 15.3) or the like.

The spring members bias the four horizontal slides 15.1 on the platform 11 to a middle or centerline M. The guiding means 15 together with the spring members have to some extent the same function as a counterweight in a conventional elevator. For this reason, they are herein referred to as virtual counterweight.

The drive 14 is connected to the lowest cross element 16 which connects the lowest pairs of arms 17.1 and 17.2 of the scissor columns. The drive 14 is arranged such that, by activating the drive 14, a force acting on said cross element 16 in the vertical direction can be applied. Thus, the drive 14 is adapted to mechanically interact with both scissor columns for applying a force in the vertical direction for moving said cross-element 16 up or down and, thus, for folding and/or unfolding the scissor assembly 13.

Preferably, the electro-mechanical drive 14 is connected with a middle section of said cross element 16. This is advantageous in view of the mechanical stability of the elevator 10 since the force generated by the drive 14 acts symmetrically on the scissor assembly 13 in the same direction in which the elevator car 12 is moved.

Another embodiment is illustrated in FIG. 2 which is an enlarged perspective view of just the lower portion of the elevator 20. The elevator 20 comprises a mounting platform 21 fixed on an essentially flat ground 22, such as a building floor. There are again four guiding means 25 situated on the mounting platform 21, as in FIGS. 1A and 1B. Each of the four guiding means 25 mounts and guides one of the lower arms 27.1 and 27.2. In FIG. 2, just one arm 27.1 is depicted for sake of simplicity. Each guiding means 25 comprises a horizontal slide 25.1 with a central through hole 25.4. Central shafts 25.3 extend through these holes 25.4. The guiding means 25 further comprise cylindrical spring members 25.5. The spring members 25.5 might be horizontally guided in the “X” direction. The spring members 25.5 push the two horizontal slides 25.1 on the right hand side of the platform 21 to the left and the two horizontal slides 25.1 on the left hand side of the platform 21 to the right. The guiding means 25 together with the spring members 25.5 have to some extent the same function as a counterweight in a conventional elevator.

In the present example, the spring members 25.5 are situated between an edge 26 of the mounting platform 21 and a vertical part 25.6 of the sliding element 25.1. The edge 26 may also be used to define the size and shape of the hoistway. As indicated in FIG. 2, side walls 28 of the hoistway may be attached to the edges 26. Just part of one side wall 28 is shown in FIG. 2. Note that in the FIGS. 1A and 1B, the side walls 9 are not attached to the mounting platform 11.

Optional damping elements 29, also referred to as terminal buffers, may be attached to the mounting platform 21.

The platform 21 further carries that central drive 24. According to the present embodiment, an electro-mechanical screw drive 24 is employed. The screw drive 24 comprises an externally threaded shaft 31 and an internally threaded nut which is not visible in FIG. 2.

The threaded shaft 31 may rotate about its longitudinal axis 31.1, as indicated in FIG. 2. The shaft 31 is drivingly connected to an electric motor 32 and the rotation of the shaft 31 is caused by the electric motor 32. The shaft 31 is therefore also referred to as a drive shaft. The electric motor 32 may be an A.C. or a D.C. motor. It preferably has an output shaft which is drivingly connected to the shaft 31. A rotation of the shaft 31 in a first angular direction about its longitudinal axis 31.1 causes the internally threaded nut to move upwards along the shaft 31 in a linear fashion. A rotation of the shaft 31 in a second angular direction would cause the nut to move downwards. The nut is connected to a sliding element 33. This sliding element 33 is guided on two vertical non-threaded shafts 34. A clamping member (not illustrated in FIG. 2) may be employed to mechanically connect the sliding element to the scissor assembly. The two non-threaded shafts 34 precisely guide the sliding element 33 as it moves up or down.

The drive 24, as illustrated in FIG. 2, serves two purposes:
(1) it is especially adapted to mechanically interact with a cross element or with another portion of the scissor assembly for applying a force to move the elevator car upwards by unfolding the scissor assembly; and
(2) it is fixed on the mounting platform 21 in an essentially upright position to provide for a vertical guidance of the two scissor columns. In other words, the drive 24 is stationary with respect to the mounting platform 21. It does not perform any tilting or pivoting movements.

Another possible drive design, not illustrated in any of the drawings, employs a threaded shaft that is fixed in an upright, preferably in a vertical position, on the mounting platform 21. An internally threaded nut (referred to as drive nut) is drivingly connected to an electric motor. This motor provides for a rotation of the nut. Depending on the direction of rotation, the nut moves either up or down. The movement of the nut can be translated in a linear sliding movement. For this purpose, the nut may interact with a respective sliding element.

The drive 24 is arranged in an essentially upright position in order to ensure that the lifting force applied by rotation of a threaded shaft relative to a nut, or by rotation of a nut relative to a threaded shaft, is directed mainly vertically into the scissor assembly.

A method for making a scissor elevator assembly, according to the present invention, is now addressed in connection with the elevator 10, illustrated in FIGS. 1A and 1B. The elevator 10 comprises the mounting platform 11 for being arranged on a substantially flat ground, the scissor assembly 13 with two vertical scissor columns for carrying the elevator car 12, and the drive mechanism 14. The method comprises the following steps, which are carried out in a fabrication site or in a model workshop:
providing the mounting platform 11;
providing the scissor assembly 13 with at least two scissor columns for carrying the elevator car 12 and being arranged underneath the elevator car 12, each scissor column comprising at least one pair of arms 17.1, 17.2;
providing the drive mechanism 14 that is capable of applying a force for unfolding the scissor assembly 13;
pre-assembling a module by securing the scissor columns to the mounting platform 11 for installation on-site, the scissor columns comprising at least one pair of arms, and
examining the function of the scissor columns.

The pre-assembled module may be prepared for shipment and installment on-site.

The step of pre-assembling the module may further comprise fixing the drive mechanism 14 to the mounting platform 11.

Furthermore, the step pre-assembling the module may further comprise providing the guiding means 15 being part of or being attached to the mounting platform 11 and establishing a mechanical connection between the arms 17.1, 17.2 of the scissor assembly 13 and the guiding means 15. The guiding means may be prepared for horizontal guiding.

Please note that these steps do not have to be carried out in the given order. All the above steps can be carried out in an environment allowing a precise assembly. The mounting platform and all its components are designed to allow a mass production, which leads to a further reduction of the costs.

Depending on the embodiment, several additional steps can be carried out when making the scissor elevator assembly. It is advantageous to carry out these steps prior to shipment of the scissor elevator assembly.

If the scissor elevator assembly is to be provided with a virtual counterweight, the respective spring elements are installed in a substantially horizontal direction so that they apply a force to the guiding means. Optionally, these spring elements may be biased.

In order to allow the scissor elevator assembly to be moved more easily wheels or roller elements can be attached underneath the mounting platform.

In order to complete the installation, electrical wires and an elevator control unit for controlling and driving the drive mechanism can be added. Preferably, the wiring and elevator control unit are tested after installation.

Furthermore, the terminal buffers 29 (cf. FIG. 2) may be attached to the mounting platform 21.

The elevator car 12, if any, can be produced separately. The car 12 is then prepared for mounting on the arms of the uppermost pairs of arms 17.7, 17.8 of the scissor assembly 13. If the elevator car 12 includes electronic components, touch buttons, switches and the like, the respective components and the wiring are added and tested.

Finally, the scissor elevator assembly is prepared for shipment. For this purpose, it may be secured by means of retaining or locking elements in order to fix the two scissor columns in a folded position. Furthermore, the whole assembly might be wrapped or it might be stored in a container or box to prevent transport and handling damages.

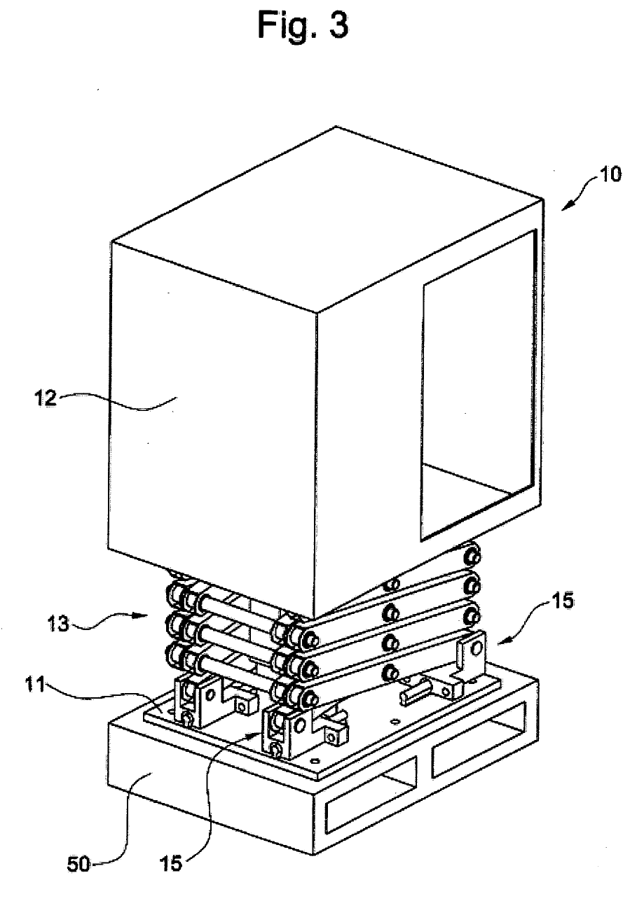

FIG. 3 shows an example of a module pre-assembled in accordance with the before-mentioned method. The module comprises the platform 11, the guiding means 15, the scissor assembly 13 and the elevator car 12. In the situation according to FIG. 3, the module is arranged on a platform 50 and ready for transport.

Transportation can be done by means of a vehicle, helicopter or crane, for example. After the scissor elevator assembly and the elevator car or cabin arrives at the installation site, it has to be moved into the right position. This can be done by a crane, helicopter, or by means of a forklift or a transport trolly. A crane or helicopter is used if the scissor elevator assembly has to be lifted into an existing hoistway or into a pit.

In cases where one has direct access to the area where the elevator is to be installed, it is easier and less expensive to use a forklift or transport trolly.

The installation on-site is easy and fast. The installation process comprises the following steps:
positioning the pre-assembled module on a substantially flat ground or floor;
aligning the module with respect to the building or landmarks;
and/or fixing the module on the ground, e.g., using screws; and
removing or disengaging retaining or locking elements, if present.

The module may be lifted into an existing hoistway or pit, prior to positioning it.

In the case that the pre-assembled module does not include the drive mechanism 14, the drive mechanism 14 can be fixed to the mounting platform 11 on-site, so that it is capable of applying a force for unfolding the scissor assembly 13.

Then, the elevator car is mounted on the scissor elevator assembly. Depending on the size and weight of the elevator car, this can be done using a crane. The elevator car is then pivotally connected on the scissor elevator assembly. In a subsequent step, the wires are connected to a power supply or power outlet and, if available, additional sensors, touch buttons and switches are connected.

Under certain circumstances, it is not desired to mount the complete car 12 on the scissor assembly (for example, if a building would not accommodate for the car to be pre-built and moved into a pit). In this case, an alternative approach is possible. Parts suited for building an elevator car may be provided and moved on-site and the elevator car 12 may be assembled on the scissor assembly 13 after the installation of the scissor assembly 13 on-site.

According to the present invention, the entire scissor-based elevator is designed with a special focus on simplifying the making and installment. In particular the on-site installation costs are drastically used, according to the present invention.

Furthermore, the logistics are simplified since the number of components to be shipped to the installation site are reduced.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A method for making a scissor elevator assembly comprising the steps of:
a) providing a mounting platform adapted to being arranged on a ground surface;
b) providing a scissor assembly having at least two scissor columns for carrying an elevator car and being arranged underneath the elevator car, each scissor column having at least one pair of arms;
c) providing a drive mechanism capable of applying a force for unfolding the scissor assembly;
d) pre-assembling a module by securing the scissor columns to the mounting platform for installation on-site; and
e) examining functioning of the scissor columns prior to installation of the module on-site.

2. The method according to claim 1 wherein said step d) further comprises fixing the drive mechanism to the mounting platform.

3. The method according to claim 1 wherein said step d) further comprises providing guiding means on the mounting platform being adapted for guiding the scissor assembly as the scissor assembly folds and unfolds and establishing a mechanical connection between the arms of the scissor assembly and the guiding means.

4. The method according to claim 3 wherein said step d) further comprises preparing the guiding means for horizontal guiding.

5. The method according to claim 1 wherein said step d) further comprises installing a spring element on the mounting platform, the spring element being adapted for applying a force to the scissor columns in order to serve as a virtual counterweight.

6. The method according to claim 5 wherein said step d) further comprises biasing the spring element.

7. The method according to claim 1 wherein said step d) further comprises attaching wheels or roller elements at the mounting platform allowing the module to be moved more easily.

8. The method according to claim 1 wherein said step d) further comprises installing on the mounting platform electrical wires and an elevator control unit for controlling and driving the drive mechanism.

9. The method according to claim 1 wherein said step d) further comprises attaching at least one terminal buffer to the mounting platform.

10. The method according to claim 1 wherein said step d) further comprises securing the scissor columns to the mounting platform by means of retaining or locking elements to fix the scissor columns in a folded position.

11. The method according to claim 1 further comprising providing an elevator car and wherein said step d) includes mounting the elevator car on the arms of uppermost pairs of the arms of the scissor assembly.

12. A method for installing a scissor elevator assembly on-site, comprising the steps of:
a) positioning a scissor elevator module on a ground surface, the module being pre-assembled with a mounting platform and a scissor assembly secured on the mounting platform for supporting an elevator car;
b) aligning the module; and
c) fixing the module on the ground surface.

13. The method according to claim 12 further comprising a step of releasing retaining elements holding the scissor assembly in a folded position.

14. The method according to claim 12 further comprising a step of lifting the module into an existing hoistway or pit prior to performing said step a).

15. The method according to claim 12 said step a) further comprises moving the module with a forklift or a transport trolly to an installation position.

16. The method according to claim 12 further comprising a step of mounting an elevator car on the scissor assembly.

17. The method according to claim 12 further comprising a step of moving parts suited for building a elevator car on-site and building the elevator car on the scissor assembly.

18. The method according to claim 12 further comprising a step of fixing a drive mechanism to the mounting platform and connecting the drive mechanism to the scissor assembly for applying a force to unfold the scissor assembly.
